(19) United States
(12) Patent Application Publication
(10) Pub. No.: US 2015/0303517 A1
(43) Pub. Date: Oct. 22, 2015

(54) SODIUM SECONDARY BATTERY

(71) Applicant: SUMITOMO CHEMICAL COMPANY, LIMITED, Chuo-ku, Tokyo (JP)

(72) Inventor: Jun-ichi KAGEURA, Tsukuba-shi, Ibaraki (JP)

(73) Assignee: SUMITOMO CHEMICAL COMPANY, LIMITED, Tokyo (JP)

(21) Appl. No.: 14/436,175

(22) PCT Filed: Oct. 17, 2013
(86) PCT No.: PCT/JP2013/078752

§ 371 Date: Apr. 16, 2015

(30) Foreign Application Priority Data
Nov. 8, 2012 (JP) 2012-246171

(51) Int. Cl. H01M 10/0567; H01M 4/485; H01M 10/054

(52) U.S. Cl. CPC H01M 10/0567; H01M 10/054; H01M 4/485; H01M 2300/0025

(57) ABSTRACT

A sodium secondary battery including a positive electrode containing a positive electrode active material capable of being doped and dedoped with sodium ions, a negative electrode containing a negative electrode active material capable of being doped and dedoped with sodium ions, and a non-aqueous electrolyte in which a sodium salt is dissolved in a non-aqueous solvent, wherein the non-aqueous electrolyte contains a silane compound represented by a specified formula.

### TECHNICAL FIELD

The invention relates to a sodium secondary battery.

### BACKGROUND ART

Because a sodium secondary battery using a non-aqueous electrolyte can generate high voltage as compared with a battery using an aqueous electrolyte, a sodium secondary battery is preferable as a battery having high energy density. Additionally, since sodium is abundant in resources and an economical material, to supply a great quantity of large size power sources is expected by mating a sodium secondary battery practically applicable.

A sodium secondary battery, in general, has at least a pair of electrodes which are compossed of a positive electrode containing a positive electrode active material capable of being doped and dedoped with sodium ions, a negative electrode containing a negative electrode active material capable of being doped and dedoped with sodium ions; and an electrolytic substance.

A sodium secondary battery has been studied which uses a non-aqueous electrolyte produced by dissolving an electrolytic salt composed of sodium hexafluorophosphate in a non-aqueous solvent corriposed of a saturated cyolic carbonic acid ester such as propylene carbonate as a non-aqueous electrolyte for a sodium secondary battery (Patent Document 1).

### Prior Art Document

### Patent Document

### Patent Document 1: JP-A-2007-35283

### SUMMARY OE THE INVENTION

However, when a sodium secondary battery using the non-aqueous electrolyte as described above is charged at a voltage higher than 4.0 V, charge-discharge efficiency (ratio of discharge capacity to charge capacity) is not sufficient. Therefore, an object of the present invention is to provide a sodium secondary battery with high charge-discharge efficiency even when charging is performed at a voltage higher than 4.0

The present invention provides a sodium secondary battery including a positive electrode containing a positive electrode active material capable of being doped and dedoped with sodium ions, a negative electrode containing a negative electrode active material capable of being doped and dedoped with sodium ions, and a non-aqueous electrolyte in which a sodium salt is dissolved in a non-aqueous solvent, wherein the non-aqueous electrolyte contains a silane compound represented by the following formula (1):

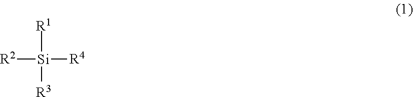

(wherein, R¹ to R⁴ each independently represent a fluorine atom, an alkyl group having 1 to 8 carbon atoras, a fluoroalkyl group having 1 to 8 carbon atoiss, an alkcouy group having 1 to 8 carbon atoms, or a fluoroalkoxy group having 1 to 8 carbon atoms; and at least one of R¹ to R⁴ is a fluorine atom, a fluoroalkyl group having 1 to 8 carbon atoms, or a fluoroalkoxy group having 1 to 8 carbon atoms).

### MODE FOR CARRYING OUT THE INVENTION

### <Sodium Secondary Battery>

A sodium secondary battery according to the present invention includes a positive electrode containing a positive electrode active material capable of being doped and dedoped with sodium ions, a negative electrode containing a negative electrode active material capable of being doped and dedoped with sodium ions, a non-aqueous electrolyte, and usually a separator as well.

The sodium secondary battery can be usually produced by obtaining an electrode group by laminating and winding a negative electrode, a separator, and a positive electrode, storing this electrode group in a battery casing, and impregnating the electrode group with a non-aqueous electrolyte.

Examples of the shape of the electrode group include a shape that the cross section taken along with a direction perpendicular to the winding axis of the electrode group is circular, oval, rectangular, or round-cornered rectangular. Examples of the shape of the battery include paper like, coin like, cylindrical and prismatic shapes.

### <Non-Aqueous Electrolyte>

A non-aqueous electrolyte used for the sodium secondary battery of the present invention contains a non-aqueous solvent and a sodium salt, wherein the sodium salt is dissolved in the non-aqueous solvent. The non-aqueous electrolyte further contains a silane compound represented by the following formula

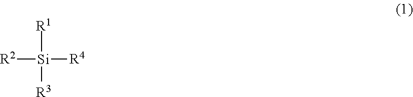

(wherein, R¹ to R⁴ each independently represent a fluorine atom, an alkyl group having 1 to 8 carbon atoms, a fluoroalkyl group having 1 to 3 carbon atoms, an alkoxy group having 1 to 8 carbon atoms, or a fluoroalkoxy group having 1 to 8 carbon atoms; and at least one of R¹ to R⁴ is a fluorine atom, a fluoroalkyl group having 1 to 8 carbon atoms, or a fluoroalkoxy group having 1 to 8 carbon atoms).

### <Silane Compound>

Hereinafter, the silane compound represented by the formula (1) will be described with reference to specific examples. R¹ to R⁴ each independently represent a fluorine atom, an alkyl group having 1 to 8 carbon atoms, a fluoroalkyl group having 1 to 8 carbon atoms, an alkoxy group having 1 to 8 carbon atoms, or a fluoroalkoxy group having ¹ to 8 carbon atoms, and at least one is a fluorine atom, a fluoroalkyl group having 1 to 8 carbon atoms, or a fluoroalkoxy group having 1 to 8 carbon atoms.

Examples of the alkyl group having 1 to 8 carbon atoms include:

linear alkyl groups such as —CH₃, —CH₂CH₃, —CH₂CH₂CH₃, —(CH₂)₃CH₃, —(CH₂)₄CH₃, —(CH₂)₅CH₃, —(CH₂)₆CH₃ and —(CH₂)₆CH₃; branched alkyl groups such as —CH(CH₃)₂, —CH₂CH(CH₃)₂, —CH(CH₃)CH₂CH₃, —C(CH₃)₃, —CH₂CH₂CH(CH₃)₂, —CH₂C(CH₃)₃, —CH₂CH(CH₃) CH₂CH₂CH₃, —CH₂CH(CH₂CH₃)CH₂CH₂CH₃, —CH₂CH(CH₂CH₃) (CH₂)₃CH₃, —CH(CH₃)CH₂CH₂CH₃, —CH(CH₂CH₃)₂, —CH(CH₃) (CH₂)₃CH₃, —CH(CH₂CH₃)CH₂CH₂CH₃, —CH(CH₃) (CH₂)₄CH₃ and —CH(CH₃) (CH₂)₅CH₃;

cycloalkyl groups such as —CH(CH₂)₂, —CH(CH₂)₃, —CH(CH(CH₃)CH₂), —CH(CH₂)₄, —CH₂CH(CH₂)₃, —CH(CH₂)₅, —CH₂CH(CH₂)₃, —CH(CH₂CH(CH₃)CH₂CH₂), —CH(CH₂)₆, —CH₂CH (CH₂)₄, —CH₂CH(CH₂)₅, —CH(CH₂CH(CH₃)CH₂CH(CH₃)CH₂), —CH(CH₂)₇ and —CH(CH₂)₇; and so forth.

Examples of the fluoroalkyl group having 1 to 8 carbon atoms include:

partially fluorine-substituted linear alkyl groups such as —CH₂F, —CHF₂, —CH₂CF₃, —CH₂CH₂CF₃, —(CH₂)₃CF₃, —(CH₂₎₄CF₃, —(CH₂)₅CF₃, —(CH₂)₆CF₃, —(CH₂)₇CF₃, —CH₂CHFCF₃, —CHFCH₂CF₃, —CH₂CHFCH₂CF₃, —CHFCH₂CHFCF₃, —(CH₂CHF)₂CF₃, —(CHFCH₂)₂CF₃, —(CH₂CHF)₃CF₃, —(CHFCH₂)₃CF₃, —CHF(CH₂CHF)₂CF₃, —CH₂(CHFCH₂)₂CF₃, —CF₂CH₂CF₃, —CH₂CF₂CF₃, —(CF₂CH₂)₂CF₃, —(CF₂CH₂)₃CF₃, —(CH₂CF₂)₃CF₃, —CH₂(CF₂CH₂)₃CF₃ and —CF₂(CH₂CF₂)₃CF₃;
partially fluorine-substituted branched alkyl groups such as —CH(CF₃)₂, —CH₂CH(CF₃)₂, —CH₂CF(CF₃₂, —CHFCF(CF₃)₂, —CH(CF₃) (CH₂CF₃), —CH(CF₃) (CHFCF₃), —C(CH₃) (CF₃₎₂, —C(CH₃)₂(CF₃), —CH₂CH₂CH(CF₃)₂, —CH₂CH₂CH(CH₃) (CF₃), —CH₂C(CF₃)₃, —CH₂C(CH₃)(CF₃)₂, —CH₂C(CF₃)(CH₃)₂, —CF₂C(CH₃)(CF₃₎₂, —CF₂C(CF₃)(CH₃)₂, —CH₂CH(CF₃)CH₂CH₂CF₃, —CH₂CH(CH₂CF₃) CH₂CH₂CF₃, —CH₂CH(CH₂CF₃)(CH₂)₃CF₃, —CF₂CH(CH₂CF₃)(CH₂)₃CF₃, —CH(CF₃)CH₂CF₃, —CH(CF₃)CH₂CH₂CF₃, —CH(CH₂CF₃)₂, —CH(CF₃)(CH₂)₃CF₃, —CH(CH₂CH₃)CH₂CH₂CF₃, —CH(CF₃)(CH₂)₄CF₃ and —CH(CF₃)(CH₂)₅CF₃;
partially fluorine-substituted cycloalkyl groups such as —CH(CHF)₂, —CH(CH₂)(CHF), —CH(CH₂)₂(CHF), —CH(CH₂)(CHF)₂, —CH(CH(CF₃)CH₂), —CH(CH(CF₃)CHF), —CH(CH₂)₃(CHF), —CH(CH₂)₂(CHF)₂, —CH₂CH(CH₂)₂(CHF), —CH(CH₂)₄(CHF), —CH_{CH(CH}₂)₂(CHF), —CH(CH₂CH(CF₃)CH₂CH₂), —CH(CH₂)₅(CHF), —CH(CH₂)₄(CHF)₂, —CH₂CH(CH₂)₄, —CH₂CH(CH₂)₅, —CH(CH₂CH(CF₃)CH₂CH(CF₃)CH₂ and —CH(CH₂)₃(CHF)CH₂)₃;
linear perrluoroalkyl groups such as —CF₃, —CF₂CF₃, —CF₂CF₂CF₃, —(CF₂)₃CF₃, —(CF₂)CF₃, —(CF₂)₅CF₃, —(CF₂)₆CF₃ and —CF₂)₇CF₃;
branched perfluoroalkyl groups such as —CF(CF₃)₂, —CF₂CF(CF₃)₂, —CF(CF₃)(CF₂CF₃), —C(CF₃)₃, —CF₂CF₂CF(CF₃)₂, —CF₂C(CF₃)₃, —CF₂CF(CF₃)CF₂CF₂CF₃, —CF₂CF(CF₂CF₃) CF₂CF₂CF₃, —CF₂CF(CF₂CF₃)(CF₂)₃CF₃, —CF(CF₃)CF₂CF₂CF₃, —CF(CF₂CF₃)₂, —CF(CF₃)(CF₂)₃CF₃, —CF(CF₂CF₃)CF₂CF₂CF₃, —CF(CF₃)(CF₂)₄CF₃ and —CF(CF₃)(CF₂)₅CF₃;
perfluorocycloalkyl groups such as —CF(CF₂)₂, —CF(CF₂)₃, —CF(CF(CF₃)CF₂), —CF(CF₂)₄, —CF₂CF(CF₂)₃, —CF(CF₂)₅, —CF₂CF(CF₂)₃, —CF(CF₂CF(CF₃)CF₂CF₂), —CF(CF₂)₆, —CF₂CF(CF₂)₄, —CF₂CF(CF₂)₅, —CF(CF₂CF(CF₃)CF₂CF(CF₃)CF₂), —CF(CF₂)₇ and —CF(CF₂)₇; and so forth.
Examples of the alkoxy group having 1 to 8 carbon atoms include:
linear alkoxy groups such as —OCH₃, —OCH₂CH₃, —OCH₂CH₂CH₃, —O(CH₂)₃CH₃, —O(CH₂)₄CH₃, —O(CH₂)₅CH₃, —O(CH₂)₆CH₃ and —O(CH₂)₇CH₃;
branched alkoxy groups such as —OCH(CH₃)₂, —OCH(CH₃)(CH₂CH₃), —OCH(CH₂CH₃)₂, —OCH(CH₃)(CH₂CH₂CH₃), —OCH(CH₂CH₃)(CH₂CH₂CH₃), —OCH(CH₂CH₂CH₃)₂, —OCH₂CH(CH₃₅CH₂CH₃, —OCH₂CH(CH₂CH₃)₂, —OCH₂CH(CH₃)CH₂CH₂CH₃, —O(CH₂)₂CH(CH₃)₂, —O(CH₂)₂CH(CH₃)(CH₂CH₃) and —O(CH₂)₂CH(CH₂CH₃)₂;
cycloalkyl group-containing alkoxy groups such as —OCH(CH₂)₂, —OCH(CH₂)₃, —OCH(CH₂)₄, —OCH(CH₂)₅, —OCH(CH₂)₅, —OCH(CH₂)₇, —OCH₂CH(CH₂)₂, —OCH₂CH(CH₂)₃, —OCH₂CH(CH₂)₄, —OCH₂CH(CH₂)₅, —OCH₂CH(CH₂)₆ and —O(CH₂)₂CH(CH₂)₂; and so forth.

Examples of the fluoroalkozy group having 1 to 8 carbon atoms include:

linear perfluoroalkoxy groups such as —OCF₃, —OCF₂CF₃, —OCF₂CF₂CF₃, —O(CF₂)₃CF₃, —O(CF₂)₄CF₃, —O(CF₂)₅CF₃, —O(CF₂)₆CF₃ and —O(CF₂)₇CF₃;
partially fluorine-substituted linear alkoxy groups such as —OCHF₂, —OCH₂F, —OCH₂CF₃, —OCHFCF₃, —OCHFCH₂CF₃, —O(CHF)₂CF₃, —OCH₂CF₂CF₃, —OCH₂CHFCF₃, —O(CH₂)₃CF₃, —O(CH₂)₂CF₂CF₃, ——O(CH₂)(CF₂)₂CF₃, —O(CHF)₃CF₃, —O(CH₂)₄CF₃, —O(CHF)₄CF₃, —O(CH₂)₅CF₃, —O(CHF)₅CF₃, —O(CH₂)₆CF₃ and —O(CH₂)₇CF₃;
branched perfluoroalkoxy groups such as —OCF(CF₃)₂, —OCF(CF₃)(CF₂CF₃), —OCH(CF₂CF₃)₂, —OCF(CF₃)(CF₂CF₂CF₃, —OCF(CF₂CF₃)(CF₂CF₂CF₃), —OCF(CF₂CF₂CF₃)₂, —OCF₂CF(CF₃)CF₂CF₃, —OCF₂CF(CF₂CF₃)CF₂CF₃, —OCF₂CF(CF₃)CF₂CF₂CF₃, —O(CF₂)₂CF(CF₃)₂, —O(CF₂)₂CF(CF₃)(CF₂CF₃) and —O(CF₂)₂CF(CF₂CF₃)₂;
partially fluorine-substituted branched alkoxy groups such as —OCH(CF₃)₂, —OCH(CF₃)(CH₂CF₃), —OCH(CH₂CF₃)₂, —OCH(CF₃)(CH₂CH₂CF₃), —OCH(CH₂₃)(CH₂CH₂CF₃), —OCH(CH₂CH₂CF₃)₂, —OCH₂CH(CF₃)CH₂CF₃, —OCH₂CH(₂CF₃)₂, —OCH₂CH(CF₃)CH₂CF₃, —O(CH₂)₂CH(CF₃)₂, —O(CH₂)₂CH(CF₃)(CH₂CF₃) and —O(CH₂)₂CH(CH₂CF₃)₂;
partially fluorine-substituted cycloalkyl group-containing alkoxy groups such as —OCH(CH₂)(CHF), —OCH(CHF)₂, —OCH(CH₂)₂(CHF), —OCH(CH₂)₃(CHF), —OCH(CH₂)₄(CHF), —OCH(CH₂)₅(CHF), —OCH(CH₂)₆(CHF), —OCHFCH(CH₂)₂, —OCHFCH(CH₂)(CHF), —OCH₂CH(CH₂)₂(CHF), —OCHFCH(CH₂)₂(CHF), —OCH₂CH(CH₂)₃(CHF), —OCH₂CH(CH₂)₄(CHF), —OCH₂CH(CH₂)₅(CHF), —O(CHF)₂CH(CH₂)₂, —OCHFCH(CH₂)₃, —OCH₂CH(CH₂)₄, —OCH₂CH(CH₂)₅ and —OCH(CH₂CH(CF₃)CH₂CH(CF₃)CH₂); and so forth.

Examples of the silane compound represented by the formula (1) specifically include silane compounds represented by the formulas (1-1) to (1-4):

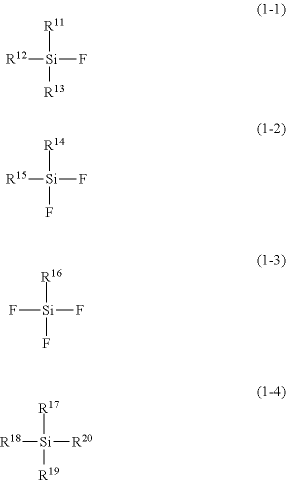

(R¹¹ to R¹⁹ each independently represent an alkyl group having 1 to 8 carbon atoms, a fluoroalkyl group having 1 to 8 carbon atoms, an alkoxy group having 1 to 8 carbon atoms, or a fluoroalkoxy group having 1 to 8 carbon atoms; and R²⁰ is a fluoroalkyl group having 1 to 3 carbon atoms or a fluoroalkoxy group having 1 to 8 carbon atoms).

Examples of the compound represented by the formula (1-1) include:

linear alkyl group-containing fluorosilanes such as (CH₃)₃SiF, (CH₃CH₂)₃SiF, (CH₃CH₂)₂(CH₃)SiF, (CH₃CH₂CH₂)₃SiF, (CH₃CH₂CH₂)₂(CH₃)SiF, (CH₃CH₂CH₂)₂(CH₃CH₂)SiF, (CH₃(CH₂)₃)₃SiF, (CH₃(CH₂)₄)₃SiF, (CH₃(CH₂)₅)₃SiF, (CH₃(CH₂)₆)₃SiF and (CH₃(CH₂)₇)₃SiF;
branched alkyl group-containing fluorosilanes such as (CH₃)₂CHCH₂SiF(CH₃)₂, CH₃)₂CH(CH₂)₂SiF(CH₃)₂, ((CH₃)₂CH(CH₂)₂)₂)₂SiF(CH₃), ((CH₃₎₂CH (CH₂)₂)₃SiF and (CH₃)₂CH(CH₂)₄SiF(CH₃)₂; cycloalkyl group-containing fluorosilanes such as (CH₂)₂CHSiF(CH₃)₂, (CH₂)₃CHSiF(CH₃)₂, (CH₂)₃CHCH₂SiF(CH₃)₂, (CH₂)₃CHCH₂SiF(CH₂CH₃)₂, (CH₂)₃CH(CH₂)₂SiF(CH₃)₂ and CH₂)₃CHCH₂SiF(CH₃)₂;
linear alkoxy group-containing fluorosilanes such as (CH₃O)₃SiF, (CH₃CH₂O)₃SiF, (CH₃O)(CH₃CH₂O)₂SiF, (CH₃(CH₂)₂O)₃SiF, (CH₃(CH₂)₂O)₂(CH₃O)SiF, (CH₃(CH₂)₃O)₃SiF, (CH₃(CH₂)₃O)₂(CH₃O)SiF, (CH₃(CH₂)₄O)₃SiF, (CH₃(CH₂)₅O)₃SiF, (CH₃(CH₂)₅O)₃SiF, (CH₃(CH₂)₆O)₃SiF and (CH₃(CH₂)₇O)₃SiF;
branched alkoxy group-containing fluorosilanes such as ((CH₃)₂CHO)₃SiF, ((CH₃₎₂CHCH₂O)₃SiF, ((CH₃)₂CH (CH₂)₂O)₃SiF, ((CH₃)₂CH(CH₂)₃O)₃SiF and ((CH₃)₂CH(CH₂)₄O)₃SiF;
alkoxy group-containing alkylfluorosilanes such as (CH₃O)₂Si(CH₃CH₂)F, (CH₃CH₂O)₂Si(CH₃)F, (CH₃O)₂Si((CH₂)₂CH₃)F, (CH₃CH₂O)₂Si((CH₂)₂CH₃)F and (CH₃(CH₂)₂O)₂Si(CH₃)F;
fluoroalkyl group-containing fluorosilanes such as (CF₃)₃SiF, (CF₃CH₂)₃SiF, (CF₃CH₂)₂(CH₃)SiF, (CH₃CH₂)₂(CF₃)SiF, (CF₃CH₂CH₂)₃SiF, (CF₃CH₂CH₂)₂(CH₃)SiF, (CF₃CF₂CH₂)₂(CH₃)SiF, (CF₃(CH₂)₄)₃SiF, (CF₃(CF)₂(CH₂)₂)₃SiF, (CF₃(CH₂)₅)₃SiF, CF₃(CH₂)₆)₃SiF, (CF₃(CHF)₆)₃SiF, (CF₃(CF)₄(CH₂)₂)₃SiF and (CF₃(CH₂)₇₎₃SiF;
fluoroalkozy group-containing fluorosilanes such as (CF₃O)₃SiF, (CF₃CH₂O)₃SiF, (CH₃O)(CH₃CH₂O)₂SiF, (CF₃(CH₂)₂O)₃SiF, (CF₃(CH₂)₂O)₂(CH₃O)SiF, (CF₃(CH₂)₃O)₃SiF, (CF₃(CH₂)₃O)₂(CH₃O) SiF, (CF₃(CH₂)₄O)₃SiF, (CF₃(CH₂)₅O)₃SiF, (CF₃(CH₂)₅O)₃SiF, (CF₃(CH₂)₆O)₃SiF, (CF₃(CF₂)₂(CH₂)₄O)₃SiF and (CF₃(CH₂)₇O)₃SiF; and so forth.

Examples of the compound represented by the formula (1-2) include:

linear alkyl group-containing difluorosilanes such as (CH₃)₂SiF₂, (CH₃CH₂)₂SiF₂, (CH₃CH₂) (CH₃)SiF₂, (CH₃CH₂CH₂)₂SiF₂, (CH₃CH₂CH₂)(CH₃)SiF₂, (CH₃CH₂CH₂)(CH₃CH₂)SiF₂, (CH₃(CH₂)₃)₂SiF₂, (CH₃(CH₂)₄)₂SiF₂, (CH₃(CH₂)₅)₂SiF₂, (CH₃(CH₂)₆)₂SiF₂ and (CH₃(CH₂)₇)₂SiF₂;
branched alkyl group-containing difluorosilanes such as (CH₃)₂CHCH₂SiF₂(CH₃), (CH₃)₂CH(CH₂)₂SiF₂(CH₃), (CH₃)₂CH(CH₂)₃SiF₂(CH₃), ((CH₃)₂CH(CH₂)₂)₂SiF₂ and (CH₃)₂CH(CH₂)₄SiF₂(CH₃);
cycloalkyl group-containing difluorosilanes such as (CH₂)₂CH(CH₃)SiF₂, (CH₂)₃CH(CH₃)SiF₂, (CH₂)₃CHCH₂(CH₃)SiF₂, (CH₂)₃CHCH₂(CH₂CH₃)SiF₂, (CH₂)₃CH(CH₂)₂(CH₃)SiF₂ and (CH₃)₃CHCH₂(CH₃)SiF₂;
linear alkoxy group-containing difluorosilanes such as (CH₃O)₂SiF2, (CH₃CH₂O)₂SiF₂, (CH₃O)(CH₃CH₂O)SiF₂, (CH₃(CH₂)₂O)₂SiF₂, (CH₃(CH₂)₂O)(CH₃O)SiF₂, (CH₃(CH₂)₃O)₂SiF₂, (CH₃(CH₂)₃O)(CH₃O)SiF₂, (CH₃(CH₂)₄O)₂SiF₂, (CH₃(CH₂)₅O)₂SiF₂, (CH₃(CH₂)₅O)₂SiF₂, (CH₃(CH₂)₆O)₂SiF₂ and (CH₃(CH₂)₇O)₂SiF₂;
branched alkoxy group-containing difluorosilanes such as ((CH₃)₂CHO)₂SiF₂, ((CH₃)₂CHCH₂O)_{SiF}₂, ((CH₃)₂CH(CH₂)₂O)₂SiF₂, ((CH₃)₂CH(CH₂)₃O)₂SiF₂ and ((CH₃)₂CH(CH₂)₄O)₂SiF₂; alkoxy group-containing alkyldifluorosilanes such as (CH₃O)₂Si(CH₃CH₂)F, (CH₃CH₂O)₂Si(CH₃)F, (CH₃O)₂Si((CH₂)₂CH₃)F, (CH₃CH₂O)₂Si((CH₂)₂CH₃)F and (CH₃(CH₂)₂O)₂Si(CH₃)F;
fluoroalkyl group-containing difluorosilanes such as (CF₃)₂SiF₂, CF₃CH₂)₂SiF₂, (CF₃CH₂)(CH₃) SiF₂, (CH₃CH₂)(CF₃)SiF₂, (CF₃CH₂CH₂)₂SiF₂, (CF₃CH₂CH₂) (CH₃)SiF₂, (CF₃CF₂CH₂)(CH₃)SiF₂, (CF₃CH₂CH₂)(CF₃)SiF₂, (CF₃CH₂CH₂)(CH₃CH₂)SiF₂, (CF₃(CH₂ )₃)₂SiF₂, (CF₃(CH₂)₄)₂SiF₂, (CF₃(CF)₂(CH₂)₂)₂SiF₂, (CF₃(CH₂)₅)₂SiF₂, (CF₃(CH₂)₆)₂SiF₂, (CF₃(CHF)₆)₂SiF₂, (CF₃(CF)₄(CH₂)₂)₂SiF₂ and (CF₃(CH₂)₇)₂SiF₂;
fluoroalkoxy group-containing difluorosilanes such as (CF₃O)₂SiF₂, (CF₃CH₂O)₂SiF₂, (CH₃O)(CF₃CH₂O) SiF₂, (CF₃(CH₂)₂O)₂SiF₂, (CF₃(CH₂)₂O)(CH₃O)SiF₂, (CF₃(CH₂)₃O)₂SiF₂, (CF₃(CH₂)₃O)(CH₃O)SiF₂, (CF₃(CH₂)₄O)₂SiF₂, CF₃(CH₂)₅O)₂SiF₂, (CF₃(CF₂)₂(CH₂)₃O)₂SiF₂, (CF₃(CH₂)₆O)₆O)₂SiF₂, (CF₃(CF₂)₂(CH₂)₄O)₂SiF₂ and (CF₃(CH₂)₇O)₂SiF₂; and so forth.

Examples of the compound represented by the formula (1-3) include:

linear alkyl group-containing trifluorosilanes such as (CH₃)SiF₃, (CH₃CH₂)SiF₃, (CH₃CH₂CH₂)SiF₃, (CH₃(CH₂)₃)SiF₃, (CH₃(CH₂)₄)SiF₃, (CH₃(CH₂)₅)SiF₃, (CH₃(CH₂)₆ ) SiF₃ and (CH₃(CH₂)₇)SiF₃;
branched alkyl group-containing trifluorosilanes such as (CH₃₎₂CHCH₂SiF₃, (CH₃)₂CH(CH₂)₂SiF₃, (CH₃)₂CH(CH₂)₃SiF₃, (CH₃)₂CH(CH₂)₄SiF₃ and (CH₃)₂CH(CH₂)₅SiF₃;
cycloalkyl group-containing trifluorosilanes such as (CH₂)₂CH_{SiF}₃, (CH₂)₃CHSiF₃, (CH₂)₃CHCH₂SiF₃, (CH₂)₃CHCH₂SiF₃, (CH₂)₃CH(CH₂)₂SiF₃ and (CH₂)₃CHCH₂SiF₃;
linear alkoxy group-containing trifluorosilanes such as (CH₃_{O)SiF}₃, (CH₃CH₂O)SiF₃, (CH₃(CH₂)₂O)SiF₃, (CH₃(CH₂)₃O)SiF₃, (CH₃(CH₂)₄O)SiF₃, (CH₃(CH₂)₅O)SiF₃, (CH₃(CH₂)₅O)SiF₃, (CH₃(CH₂)₆O)SiF₃ and (CH₃(CH₂)₇O)SiF₃;
branched alkoxy groups-containing trifluorosilanes such as ((CH₃)₂CHO)SiF₃, ((CH₃)₂CHCH₂O)SiF₃, ((CH₃)₂CH(CH₂)₂O)SiF₃, ((CH₃)₂CH(CH₂)₃O)SiF₃ and ((CH₃)₂CH(CH₂)₄O)SiF₃;
fluoroalkyl group-containing trifluorosilanes such as (CF₃)SiF₃, (CF₃CH₂)SiF₃, (CF₃CH₂CH₂)SiF₃, (CF₃CF₂CH₂) SiF₃, (CF₃CF₂CHF)(CH₃)SiF₃, (CF₃(CH₂)₃)SiF₃, (CF₃(CH₂)₄)SiF₃, (CF₃(CF)₂(CH₂)₂)SiF₃, (CF₃(CH₂)₅)SiF₃, (CF₃(CH₂)₆)SiF₃, (CF₃(CHF)₆)SiF₃, (CF₃(CF)₄(CH₂)₂)SiF₃ and (CF₃(CH₂)₇)SiF₃;
fluoroalkoxy group-containing trifluorosilanes such as (CF₃O)SiF₃, (CF₃CH₂O)SiF₃, (CF₃(CH₂)₂O)SiF₃, (CF₃(CH₂)₃O)SiF₃, (CF₃(CH₂)₄O)SiF₃, (CF₃(CH₂)₅O)SiF₃, (CF₃(CF₂)₂(CH₂)₂O)SiF₃, (CF₃(CH₂)₆O)SiF₃, (CF₃(CF₂)₂(CH₂)₄O) SiF₃ and (CF₃(CH₂)₇O)SiF₃; and so forth.

Examples of the compound represented by the formula (1-4) include:

fluoroalkylsilanes such as (CH₂F )Si(CH₃)₃, (CHF₂)Si(CH₃)₃, (CF₃)Si(CH₃)₃, (CH₂F)Si(CH₃CH₂)₃, (CHF₂)Si(CH₃CH₂)₃, (CF₃)Si(CH₃CH₂)₃, (CF₃CH₂)₃Si(CH₃), (CF₃CH₂)₃Si(CHF₂), (CF₃CH₂)₃Si(CF₃), (CF₃CH₂)₄Si, (CF₃CH₂CH₂)Si(CH₃)₃, (CF₃CH₂CH₂ )₄Si , (CF₃CF₂CF₂)₄Si, (CF₃CF₂CF₂)Si(CH₃)₃, (CF₃(CH₂)₄)Si(CH₃)₃, (CF₃(CH₂)₄)Si(CH₃)₃, (CF₃(CH₂)₅)Si(CH₃)₃, (CF₃(CF₂)₅)Si(CH₃)₃, (CF₃(CF₂)₂(CH₂)₃)Si(CH₃)₃ and (CF₃(CF₂)₅)Si(CF₃)₃;
fluoroalkoxysilanes such as (CH₃)₃Si(OCF₃), (CH₃)₂Si(OCF₃)₂, CH₃Si(OCF₃)₃, (CH₃CH₂)Si(OCF₃)₃, (CH₃CH₂)₃Si(OCF₃), (CH₃CH₂)₃Si(OCH₂CF₃) , (CH₃CH₂)₃Si(O(CH₂)₂CF₃), (CH₃CH₂)₃Si(O(CH₂)₃CF₃), (CH₃CH₂)₃Si(O(CH₂)₄CF₃), (CH₃CH₂)₃Si(O(CH₂)₆CF₃), (CH₃CH₂)₃Si(O(CH₂)₃(CF₂)₃CF₃), (CH₃CH₂)₃Si(O(CH₂)₂(CF₂)₂CF₃), (CH₃(CH₂)₂)₃Si(OCF₃), (CH₃(CH₂)₂) Si(OCF₃)₃, (CH₃(CH₂)₂)₃Si(OCF₃), (CH₃(CH₂)₂)₃Si(OCH₂CF₃), (CH₃CH₂)₃)Si(OCF₃)₃, (CH₃(CH₂)₃)Si(OCF₃)₃, (CH₃(CH₂)₃)Si(OCH₂CF₃)₃, (CH₃(CH₂)₄)Si(OCF₃)₃, (CH₃(CH₂)₃)Si(OCF₃)₃, (CH₃(CH₂)₆)Si(OCF₃)₃ and (CH₃(CH₂)₇)Si(OCF₃)₃;
fluoroalkyl group-containing alkoxysilanes such as (CF₃)Si(OCH₃)₃, (CF₃) (CH₃)Si(OCH₃)₂, (CF₃CH₂)(CH₃)Si(OCH₃)₂, (CF₃CH₂CH₂)(CH₃)Si(OCH₃)₂, (CF₃CH₂)Si(OCH₃)₃, (CF₃CH₂)Si(OCH₂CH₃)₃, (CF₃CCH₂)(CH₃)Si(OCH₂CH₃)₂, (CF₃CH₂CH₂)(CH₃)Si(OCH₂CH₃)₂, (CF₃CH₂)Si(O(CH₂)₂CH₃)₃, (CF₃CH₂)Si(O(CH₂)₃CH₃)₃, (CF₃CH₂)Si(O(CH₂)₅CH₃)₃, (CF₃CH₂)Si(O(CH₂)₇CH₃)₃, (CF₃(CH₂)₂)(CH₃)Si(O(CH₂)₇CH₃)₂, (CF₃CH₂)₃Si(O(CH₂)₇CH₃), (CF₃CH₂CH₂)Si(OCH₃₎₃, (CF₃CH₂CH₂)₂Si(OCH₃)₂, (CF₃CH₂CH₂)₃Si(OCH₃), (CF₃CF₂CH₂)Si(OCH₃)₃, (CF₃CF₂CH₂)₂Si(OCH₃)₂, (CF₃CH₂CH₂)Si(OCH₂CH₃)₃, (CF₃(CH₂)₃)Si(OCH₃)₃, (CF₃(CH₂)₄)Si(OCH₃)₃, (CF₃(CH₂)₄)₃Si(OCH₃), (CF₃)CH₂)₅)Si(OCH₃)₃, (CF₃(CH₂)₅)₃Si(OCH₃), (CF₃(CH₂)₆)Si(OCH₃)₃, (CF₃(CH₂)₇)Si(OCH₃)₃ and (CF₃(CF₂)₄(CH₂)₃)Si(OCH₃)₃; and so forth.

In the formulas (1-1) to (1-3), each R¹¹ to R¹⁶ is preferably a linear alkyl group, a linear alkoxy group, a linear fluoroalkyl group or a linear fluoroalkoxy group. Preferred as a linear alkyl group are —CH₃, —CH₂CH₃, —CH₂CH₂CH₃ and —(CH₂)₃CH₃. Preferred as a linear alkoxy group are —OCH₃, —OCH₂CH₃, —OCH₂CH₂CH₃ and —O(CH₂)₃CH₃. Preferred as a linear fluoroalkyl group are —CH₂F, —CHF₂, —CH₂CF₃, —CH₂CH₂CF₃, —(CH₂)₃CF₃, —CF₃, —CF₂CF₃, —CF₂CF₂CF₃ and —CF₂)₃CF₃. Preferred as a linear fluoroalkoxy group are —OCF₃, —OCHF₂, —OCH₂F, —OCH₂CF₃, —OCF₂CF₃, —OCHFCF₃, —OCHFCH₂CF₃, —CCF₂CF₂CF₃, —O(CHF)₂CF₃, —OCH₂CF₂CF₃, —OCH₂CHFCF₃, —O(CH₂)₃CF₃, —O(CF₂)₃CF₃, —O(CH₂)₂CF₂CF₃ and —O(CH₂)(CF₂₎₂CF₃.

In the formula (1-4), each R¹⁷ to R¹⁹ is preferably a linear alkyl group or a linear alkoxy group. Preferable linear alkyl groups are —CH₃, —CH₂CH₃, —CH₂CH₂CH₃ and —(CH₂)₃CH₃. Preferable linear alkoxy groups are —OCH₃, —OCH₂CH₃, —OCH₂CH₂—CH₃ and —O(CH₂)₃CH₃.

In the formula (1-4), R²⁰ is preferably a fluoroalkyl group having 1 to 4 carbon atoms or a fluoroalkoxy group having 1 to 4 carbon atoms, and is preferably, for example, —CF₃, —CH₂CF₃, —CF₂CF₃, —CH₂CH₂CF₃, —CH₂CF₂CF₃, —(CF₂)₂CF₃, —(CH₂)₃CF₃, —(CH₂)₂(CF)CF₃, —(CH₂)(CF)₂CF₃, —(CF₂)₃CF₃, —OCF₃, —OCHF₂, —OCH₂F, —OCH₂CF₃, —OCF₂CF₃, —OCHFCF₃, —OCHFCH₂CF₃, —OCF₂CF₂CF₃, —O(CHF)₂CF₃, —OCH₂CF₂CF₃, —OCH₂CHFCF₃, —O(CH₂)₃CF₃, —O(CF₂)₃CF₃, —O(CH₂)₂CF₂CF₃ and —O(CH₂)(CF₂)₂CF₃.

The non-aqueous electrolyte used for the sodium secondary battery of the present invention contains one or more kinds of the silane compounds represented by the formula (1). In the present invention, the silane compound represented by the formula (1) contains one or more fluorine atoms and preferably 3 or more fluorine atoms. The silane compound represented by the formula (1-1) or the formula (1-4), that is, the silane compound represented by the following formula (1-1) or the formula (1-4) is preferable because it is easily synthesized and economical.

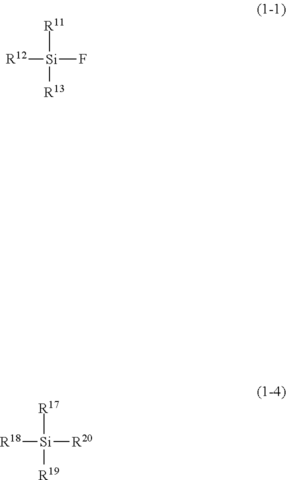

(wherein, R¹¹, R¹², R¹³, R¹⁷, R¹⁸ and R₁₉ each independently represent an alkyl group having 1 to 8 carbon atoms, a fluoroalkyl group having 1 to 8 carbon atoms, an alkoxy group having 1 to 8 carbon atoms, or a fluoroalkoxy group having 1to 8 carbon atoms; and R²⁰ is a fluoroalkyl group having 1 to 8 carbon atoms or a fluoroalkoxy group having 1 to 8 carbon atoms).

In the sodium secondary battery of the present invention, the non-aqueous electrolyte preferably contains the silane compound represented by the formula (1) in an amount of not less than 0.01% by volume and more preferably not less than 0.05% by volume in the non-aqueous electrolyte from the viewpoint of an increase in charge-discharge efficiency, and preferably not more than 10% by volume and more preferably not more than 2% by volume from viewport, of a decrease in inner resistance.

The reason why the charge-discharge efficiency is increased when the non-aqueous electrolyte used for the present invention contains the silane compound represented by the formula (1) is not necessarily certain, but it is supposed that since the silane compound is internally polarized, the silane compound preferentially can converge on the positive electrode, resulting in suppressing the decomposition of the non-aqueous electrolyte.

### <Sodium Salt>

Examples of the sodium salt used in the non-aqueous electrolyte include NaClCO₄, NaPF₆, NaAsF₆, NaSbF₆, NaBF₄, NaCF₃SO₃, NaN(SO₂CF₃)₂, NaBC₄O₈, a lower aliphatic carboxylic acid sodium salt, NaAlCl₄, and so forth, and two or more of these sodium salts may be used in the form of a mixture. Among these, it is preferable to use a sodium salt which contains at least one fluorine atom; and which is selected from the group consisting of NaPF₆, KaBF₄, NaAsF₆, NaSbF₆, NaCF₃SO₃ and NaN(SO₂CF₃)₂, and it is more preferable to use a sodium salt which contains at least one fluorine atom and which is selected from the group consisting of NaPF₆, NaBF₄ and NaN(SO₂CF₃)₂. Particularly, NaPF₆ is stable in a wide range of potential and easily dissolved in a non-aqueous solvent, and therefore the non-aqueous electrolyte preferably contains NaPF₆ as a sodium salt. In the present invention, the sodium salt in the non-aqueous electrolyte serves as an electrolytic substance.

The concentration of the sodium salt in the non-aqueous electrolyte is normally about 0.1 to 2 mol./L, preferably 0.3 to 1.5 mol/L, and more preferably 0.5 to 1.3 mol/L.

### <Non-Aqueous Solvent>

A non-aqueous solvent in the non-aqueous electrolyte contains one or more kinds of solvents selected from the group consisting of a cyclic carbonic: acid ester, a cyclic sulfone, a lactone and a cyclic sulfonic acid ester.

Examples of the cyclic carbonic acid ester include propylene carbonate, ethylene carbonate and butylene carbonate.

Examples of the cyclic sulfone include sulfolane, methylsulfolane and ethylsulfolane.

Examples of the lactone include γ-butyrolactone, γ-valerolactone, δ-valerolactone and ε-caprolactone.

Examples of the cyclic sulfonic acid ester include 1,3-propanesultone and 1,4-butanesultone.

Since the non-aqueous solvent has high dielectric constant, it easy dissolves the sodium salt used in the present invention therein and provides a non-aqueous electrolyte with good conductivity. Above all, the non-aqueous solvent preferably contains one or more kinds of solvents selected from the group consisting of propylene carbonate and ethylene carbonate.

The non-aqueous solvent may contain a cyclic carbonic acid ester containing a fluorine atom. Examples of the cyclic carbonic acid ester containing a fluorine atom include fluoroethylene carbonate (FEC: 4-fluoro-1,3-dioxolan-2-one), difluoroethylene carbonate (DFEC: trans- or cis-4,5-difluoro-1, 3-dioxolan-2-one), and so forth.

The cyclic carbonic acid ester containing a fluorine atom is preferably fluoroethylene carbonate.

In the present invention, the cyclic carbonic acid ester containing a fluorine atom is contained in an amount of not less than 0.01% by volume, preferably not less than 0.1% by volume, more preferably not less than 0.5% by volume, and furthermore preferably not less than 0.7% by volume in the non-aqueous electrolyte from viewpoint of an increase in charge-discharge efficiency and an improvement in charge-discharge cycle characteristic, and also not more than 10% by volume, preferably not more than 8% by volume, more preferably not more than 5% by volume, and furthermore preferably not more than 2.5% by volume in the non-aqueous electrolyte from viewpoint of preventing an increase in inner resistance of battery.

The non-aqueous solvent may contain a low viscosity solvent for the purpose of decreasing viscosity. Examples of the low viscosity solvent include chain carbonic acid esters such as dimethyl carbonate, diethyl carbonate arid ethyl methyl carbonate; cyclic ethers such as tetrahydrofuran, methyltetrahydrofuran, dioxane, dioxolane, 12-crown-4-ether and 18-crown-6-ether; and chain ethers such as dimethoxymethane and dimethoxymethane. The non-aqueous electrolyte containing a low viscosity solvent may have good conductivity, and can lower the inner resistance of battery.

The non-aqueous electrolyte may contain one or more kinds of surfactants selected from trioctyl phosphate, perfluoroalkyl group-containing polyoxyethylene ethers, perfluorooctanesulfonic acid esters and so forth in order to improve the wettability with a separator. The addition amount of a surfactant is preferably not more than 3% by weight and more preferably 0. 01 to 1% by weight based on the total weight of the non-aqueous electrolyte.

### <Positive Electrode>

In the present invention, the positive electrode contains a positive electrode active material capable of being doped and dedoped with sodium ions. The positive electrode may include a current collector and a positive electrode mixture deposited on the current collector and containing the positive electrode active material. The positive electrode mixture may contain a conductive material or a binder besides the positive electrode active material as described above, if necessary.

### <Positive Electrode Active Materials>

In the present invention, the positive electrode active material is composed of a sodium-containing transition metal compound, and the sodium-containing transition metal compound can be doped and dedoped with sodium ions.

Examples of the sodium-containing transition metal compound include the following compounds. That is,

oxides represented by NaM³ₐ₁O₂ such as NaFeO₂, NaMnO₂, NaNiO₂ and NaCoO₂, oxides represented by Na_{0.44}Mn₁₋ₐ₂M³ₐ₂O₂, and oxides represented by Na_{0.7}Mn₁₋ₐ₂Mₐ₂O_{2.05} (M³ is one or more transition metal elements; 0<a1<1; 0<a2<1);
oxides represented by Na_{b1}⁴_{c}Si₁₂O₃₀ (M⁴ is one or more transition metal elements; 2<b1≦6; 2≦c≦5) such as Na₆Fe₂Si₁₂O₃) and Na₂Fe₅Si₁₂O₃₀;
oxides represented by NaₐM⁵ₑSi₆O₁₈ (M₄ is one or more transition metal elements; 2≦d≦6; 1≦e≦2) such as Na₂Fe₂Si₆O₁₈ and Na₂MnFeSi₆O₁₈;
oxides represented by Na_{f}M⁶_{g}Si₂O₆ (M₆ is one or more elements selected from the group consisting of transition metal elements, Mg and Al; 1≦f≦2; 1≦g≦2) such as Na₂FeSiO₆; phosphates such as NaFePO₄, NaMnPO₄ and Na₃Fe₂(PO₄)₃; fluorophosphates such as Na₂FePO₄F, Na₂VPO₄F, Na₂MnPO₄F, Na₂CoPO₄F and Na₂NiPO₄F;
fluorosulfates such as NaFeSO₄F, NaMnSO₄F, NaCoSO₄F and NaFeSO₄F;
borates such as NaFeBO₄ and Na₃Fe₂(BO₄)₃;
fluorides represented by Na_{b}M⁷F₆(M⁷ is one or more transition metal elements; 2≦h≦3) such as Na₃FeF₆ and Na₂MnF; and so forth.

In the present invention, a composite metal oxide represented by the following formula (A) can be preferably used as the positive electrode active material. This composite metal oxide is a sodium-containing transition metal oxide. Use of the composite metal oxide represented by the following formula (A) as the positive electrode active material improves the charge-discharge capacity of battery:

NaₐM¹_{b}M²O₂ (A)

(wherein, M¹ represents one or more elements selected from the group consisting of Mg, Ca , Sr and Ba; M² represents one or more elements selected from the group consisting of Mn, Fe, Co, Cr, V, Ti and Ni; a is a value in a range of not less than 0.5 and not more than 1; b is a value in a range of not less than 0 and not more than 0.5; and a+b is a value in a range of not less than 0.5 and not more than 1).

### <Conductive Material>

A carbon material can be used as the conductive material. Examples of the carbon material include a graphite powder, carbon black (e.g., acetylene black, Ketjen black, furnace black, etc.), a fibrous carbon material (e.g., carbon nanotubes, carbon nanofibers, vapor-phase grown carbon fibers, etc.), and so forth. The carbon material has a large surface area and when the carbon material is added in a small amount to an electrode mixture, it can increase the conductivity inside of an electrode to be obtained and also improve charge-discharge efficiency and large current discharge property. The ratio of the conductive material in the positive electrode mixture is usually 5 to 20 parts by weight based on 100 parts by weight of the positive electrode active material, and the positive electrode mixture may contain two or more kinds of conductive materials.

### <Binder>

Examples of the binder used for the electrode include polymers of a fluorine compound. Examples of the fluorine compound include:

fluorinated olefins such as perfluorohexylethylene, tetrafluoroethylene, trifluoroethylene, vinylidene fluoride, vinyl fluoride, chlorotrifluoroethylene and hexafluoropropylene;
fluorinated alkyl-substituted olefins such as perfluorohexylethylene and perfluorohexylethylene;
fluorinated alkyl-substituted (meth)acrylates such as trifluoroethyl (meth)acrylate, trifluoropropyl(meth)acrylate and pentafluoropropyl (meth)acrylate;
fluoroalkylene oxides such as hexafluoropropylene oxide;
fluoroalkyl vinyl ethers such as perfluoropropyl vinyl ether and perfluorohexyl vinyl ether;
fluoroketones such as pentafluoroethylketone and hexafluoroacetone; and so forth.

Examples of the binder other than the polymers of a fluorine compound include addition polymers of a fluorine atom-free monomer having an ethylenic double bond. Examples of the monomer include:

olefins such as ethylene, propylene, 1-butene, isobutene and 1-pentene;
conjugated dienes such as 1,2-propadiene, 1,3-butadiene, isoprene and 1,3-pentadiene; carboxylic acid vinyl esters such as vinyl acetate, vinyl propionate and vinyl laurate;
vinyl aryls such as styrene, 2-vinylnaphthalene, 9-vinylanthracene and vinyltolyl;
unsaturated carboxylic acids such as acrylic acid, methacrylic acid and crotonic acid;
unsaturated dicarboxylic acids such as maleic acid, fumaric acid, metaconic acid, glutaconic acid, metaconic acid and crotonic acid;
vinyl ethers such as 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, 6-hydroxyhexyl vinyl ether and diethyleneglycol monovinyl ether;
vinyl inorganic acids such as vinylphosphoric acid and vinylsulfonic acid;
acrylic acid esters such as methyl acrylate, ethyl acrylate, propyl acrylate, isopropyl acrylate, butyl acrylate, isobutyl acrylate, tert-butyl acrylate, pentyl acrylate, methoxyethyl acrylate, ethoxyethyl acrylate, 2-ethylhexyl acrylate, 2-hydroxyethyl acrylate, 2-hydroxypropyl acrylate, dimethylaminoethyl acrylate, diethylaminoethyl acrylate, benzyl acrylate, phenylethyl acrylate, glycidyl acrylate, phosphoric acid acrylate and sulfonic acid acrylate; methacrylic acid esters such as methyl methacrylate, ethyl methacrylate, propyl methacrylate, isopropyl methacrylate, butyl methacrylate, isobutyl methacrylate, tert-butyl methacrylate, pentyl methacrylate, methoxyethyl methacrylate, ethoxyethyl methacrylate, pentyl methacrylate, 2-ethylhexyl methacrylate, 2-hydroxyethyl methacrylate, 2-hydroxypropyl methacrylate, dimethylaminoethyl methacrylate, diethylaminoethyl methacrylate, benzyl methacrylate, phenylethyl methacrylate, glycidyl methacrylate, phosphoric acid acrylate and sulfonic acid acrylate;
crotonic acid esters such as methyl crotonate, ethyl crotonate, propyl crotonate, butyl crotonate, isobutyl crotonate, tert-butyl crotonate, pentyl crotonate, n-hexyl crotonate, 2-ethylhexyl crotonate and hydroxypropyl crotonate;
unsaturated dicarboxylic acid esters such as dimethyl maleate, monooctyl maleate, monobutyl maleate and monooctyl itaconate; inorganic acid esters such as methyl vinylphosphate, ethyl vinylphosphate, propyl vinylphosphate, methyl vinylsulfonate, ethyl vinylsulfonate and propyl vinylsulfonate;
unsaturated alcohols such as vinyl alcohol and allyl alcohol;
unsaturated nitriles such as acrylonitrile and methacrylonitrile;
(meth)acrylamide monomers such as (meth)acrylamide, N-methylol (meth)acrylamide and diacetone acrylamide; monomers containing a halogen atom other than fluorine such as monomers containing chlorine, bromine and iodine, vinyl chloride and vinylidene chloride;
cyclic vinyl lactams such as N-vinylpyrrolidone and N-vinylcaprolactam; and so forth.

In the present invention, the binder has a glass transition temperature of preferably from −50 to 0° C. When the glass transition temperature is set within the above-mentioned range, the flexibility of the obtained electrode can be improved and it is made possible to obtain a sodium secondary battery sufficiently usable even in low temperature environments.

Preferable Examples of the binder in the present invention include:

fluoro resins such as polytetrafluoroethylene, polychlorotrifluoroethylene, tetrafluoroethylene-perfluoroalkyl vinyl ether copolymer, ethylene-tetrafluoroethylene copolymer, ethylene-chlorotrifluoroethylene copolymer and tetrafluoroethylene-hexafluoropropylene copolymer;
fluororubbers such as vinylidene fluoride-hexafluoropropylene copolymer, vinylidene fluoride-tetrafluoroethylene copolymer, vinylidene fluoride-hexafluoropropylene-tetrafluoroethylene copolymer, vinylidene fluoride-pentafluoropropylene copolymer, vinylidene fluoride-pentafluoropropylene-tetrafluoroethylene copolymer, vinylidene fluoride-perfluoromethyl vinyl ether-tetrafluoroethylene copolymer and vinylidene fluoride-chlorotrifluoroethylene copolymer;
acrylic polymers such as polyacrylic acid, polyacrylic acid alkali salts (e.g., sodium polyacrylate, potassium polyacrylate, lithium polyacrylate, etc.), polyalkyl acrylate (wherein the number of carbon atoms in an alkyl moiety is 1 to 20), acrylic acid-alkyl acrylate (wherein the number of carbon atoms in an alkyl moiety is 1 to 20) copolymer, polyacrylonitrile, acrylic acid-alkyl acrylate-acrylonitrile copolymer, polyacrylamide, acrylonitrile-butadiene copolymer and acrylonitrile-butadiene copolymer hydride; methacrylic polymers such as polymethacrylic acid, polyalkyl methacrylate (wherein the number of carbon atoms in an alkyl moiety of an alkyl group is 1 to 20) and methacrylic acid-alkyl methacrylate copolymer;
olefinic polymers such as polyvinyl alcohol (partially saponified or completely saponified), ethylene-vinyl alcohol copolymer, polyvinylpyrrolidone, ethylene-vinyl acetate copolymer, ethylene-vinyl acetate-alkyl acrylate (wherein the number of carbon atoms in an alkyl moiety of an alkyl group is 1 to 20) copolymer, ethylene-methacrylic acid copolymer, ethylene-acrylic acid copolymer, ethylene-alkyl methacrylate copolymer, ethylene-alkyl acrylate copolymer and ethylene-acrylonitrile copolymer; and
styrene-containing polymers such as acrylonitrile-styrene-butadiene copolymer, styrene-acrylonitrile copolymer, styrene-butadiene copolymer and styrene-butadiene copolymer hydride.

Particularly, when a copolymer containing a structural unit derived from a vinylidene halide is used, it is easy to obtain an electrode with high electrode mixture density and the volume energy density of battery can be improved, and therefore it is preferable.

The polymer can be obtained by emulsion polymerization, suspension polymerization, or dispersion polymerization. The polymer can be also obtained by solution polymerization, radiation polymerization, or plasma polymerization.

An emulsifier and a dispersant used for emulsion polymerization, suspension polymerization and dispersion polymerization may be those which are used for normal emulsion polymerization methods, suspension polymerization methods, dispersion polymerization methods, etc. Usable are specifically protective colloids such as hydroxyethylcellulose, methylcellulose and carboxymethylcellulose; nonionic surfactants such as polyoxyethylene alkyl ether, polyoxyethylene alkylphenol ether, polyoxyethylens-polyoxypropylene block copolymer, polyoxyethylene fatty acid ester and polyoxyethylene sorbitan fatty acid ester; anionic surfactants such as alkyl sulfate, alkylbenzene sulfonate, alkyl sulfosuccinate, alkyldiphenyl ether disulfonate, polyaxyethylene alkylsulfate and polyoxyethylene alkyl phosphate. One or more kinds of emulsifiers and dispersants maybe used. The addition amount of the emulsifier and the dispersant may be arbitrarily set, and usually about 0.01 to 10 parts by weight based on the total monomer amount of 100 parts by weight; however, depending on the condition of polymerization, it is not necessarily required to use the emulsifier and the dispersant.

As the binder, a commercially available binder can be used.

### <Positive Electrode Production Method>

The positive electrode is produced by supporting a positive electrode mixture containing a positive electrode active material capable of being doped and dedoped with sodium ions on a positive electrode current collector. A method for supporting a positive electrode mixture on a positive electrode current collector may be a method including preparing a positive electrode mixture paste composed of a positive electrode active material, a conductive material, a binder and solvent, kneading the paste, applying the obtained positive electrode mixture paste to the positive electrode current collector, and drying the paste. A method for applying the positive electrode mixture paste to the current collector is not particularly limited. Examples of the method include a slit die coating method, a screen coating method, a curtain coating method, a knife coating method, a gravure coating method, an electrostatic spraying method, and so forth. The drying to be performed after the application maybe performed by heat treatment, air blow drying, vacuum drying, or the like. When the drying is performed by heat treatment, the temperature is usually around 50 to 150° C. Further, pressing may be performed after the drying. Examples of the pressing method include mold pressing, roll pressing, and so forth. The electrode can be produced by the method a described above. The thickness of the electrode mixture is usually around 5 to 500 μm.

The ratio of the positive electrode mixture components in the positive electrode mixture paste, that is, the ratio of the positive electrode active material, conductive material and binder in the positive electrode mixture paste is usually 40 to 70% by weight from viewpoint of the thickness of the obtained electrode and coatability.

In the positive electrode, examples of the current collector include conductors such as Al, Ni, and stainless steel, and Al is preferred in terms of being easy to shape into a thin film and inexpensive. Examples of the shape of the current-collector include a shape of foil, flat plate, mesh, net, lath, punching metal and embossed one, and combinations thereof (e.g., meshed flat plate ). Irregularities may be formed on the surface of the current collector by etching.

### <Positive Electrode Active Material Production Method>

The sodium-containing transition metal oxide, which is one example of the positive electrode active materials, can be produced by calcining a mixture of metal-containing compounds having such composition that produce the sodium-containing transition metal oxide by calcining. Specifically, the compound can be produced by calcining the mixture which is obtained through weighing and mixing metal-containing compounds containing corresponding metal elements so as to nave predetermined composition. For example, a sodium-containing transition metal oxide having a metal element ratio represented by Na:Mn:Fe:Ni=1:0.3:0.4:0.3, which is a preferred metal element ratio, can be produced by calcining and mixing the mixture which is obtained through weighing and mixing raw materials of Na₂CO₃, MnO₂, Fe₃O₄and Ni₂O₃ in such a way that the molar ratio of Na:Mn:Fe:Ni is 1:0.3:0.4:0.3. When the sodium-containing transition metal oxide contains M¹ (M¹ is one or more elements selected from the group consisting of Mg, Ca, Sr and Ba), a raw material containing M¹ may be added at the time of mixing.

As the metal-containing compounds which may be used for producing the sodium-containing transition metal oxide to be used for she present invention, an oxide or a compound which is formed into an oxide by being decomposed and/or oxidized at a high temperature, such as hydroxides, carbonates, nitrates, halides and oxalates, may be used. Examples of the sodium compound include one or more compounds selected from the group consisting of sodium hydroxide, sodium chloride, sodium: nitrate, sodium peroxide, sodium sulfate, sodium hydrogen carbonate, sodium oxalate and sodium carbonate, and hydrates thereof. Sodium carbonate is more preferable in terms of handling. Preferable example of manganese compound is MnCo, preferable example of iron compound is Fe₃O₄, and preferable example of nickel compound is Ni₂O₃. These metal-containing compounds may be hydrates.

The metal-containing compound mixture can also be obtained by producing metal-containing compounds by, for example, the following precipitation method and mixing the obtained metal-containing compounds with the sodium compound.

Specifically, the precipitation method is a method for obtaining a precipitate containing the metal-containing compounds by using a compound such as a chloride, a nitrate, an acetate, a formate or an oxalate for the raw material of M² (here, M² means the same as described above and represents one or more elements selected from the group consisting of Mn, Fe, Co, Cr, V, Ti and Ni), dissolving the compounds in water, and bringing the obtained aqueous solutions into contact with a precipitant. Among the raw materials, a chloride is preferable. In the case of using a raw material which is hardly soluble in water, i.e., in the case of using as the raw material, for example, an oxide, a hydroxide or a metal material, an aqueous solution containing M² can be obtained by dissolving the raw materials in an acid such as hydrochloric acid, sulfuric acid, or nitric: acid, or an aqueous solution of these acids.

As the precipitant, one or more compounds selected from the group consisting of LiOH (lithium hydroxide), NaOH (sodium hydroxide), KOH (potassium hydroxide), Li₂CO₃ (lithium carbonate), Na₂CO₃ (sodium carbonate), K₂CO₃ (potassium carbonate), (NH₄)₂CO₃ (ammonium carbonate) and (NH₂)₂CO (urea) may be used, or hydrates of one or more of the compounds may also be used, or the compound and the hydrate may foe used in combination. It is preferred to use the precipitant in the form of an aqueous solution by dissolving the precipitant in water. The concentration of the compound in an aqueous solution of the precipitant is about 0.5 to 10 mol/L, and preferably about 1 to 8 mol/L. As the precipitant, KOH is preferred, and an aqueous KOH solution with KOH dissolved in water is more preferred. As the precipitant in the form of an aqueous solution, ammonia water may be cited, and this may be used in combination with an aqueous solution of the compound.

Examples of the method for bringing the aqueous solution containing M² into contact with the precipitant include a method for adding the precipitant (including a precipitant in the form of an aqueous solution) to the aqueous solution containing M²; a method for adding the aqueous solution containing M² to the precipitant in the form of an aqueous solution; and a method for adding, to water, the aqueous solution containing M² and the precipitant (including a precipitant in the form of an aqueous solution). It is preferred that the addition maybe accompanied by stirring. Among the methods for contact as described above, a method for adding the aqueous solution containing M² to the precipitant in the form of an aqueous solution is preferred in terms of the ease of keeping the pH and the ease of controlling the particle diameter. In this case, the pH tends to decrease with the addition of the aqueous solution containing M² to the precipitating agent in the form of an aqueous solution. It is preferred to add the aqueous solution containing M² while controlling the pH to be 9 or more, preferably 10 or more. This control can also be performed by adding the precipitant in the form of an aqueous solution.

As a result of the contact as described above, the precipitate can be obtained. The precipitate contains the metal-containing compound.

After the contact of the aqueous solution containing M² with the precipitant, a slurry is usually obtained, and solid-liquid separation of the slurry may be performed to recover the precipitate. The solid-liquid separation may be performed by any method, and from viewpoint of operability, a method by the solid-liquid separation such as filtration is preferably used, and a method in which a liquid component is evaporated by heating such as spray-drying may be used. The recovered precipitate may be subjected to washing, drying, and so forth. An excess precipitant component may happnet to adhere to the precipitate obtained after the solid-liquid separation, and the excess component can be reduced by washing. As a washing liquid used in the washing, it is preferred to use water. Further, a water-soluble organic solvent such as alcohol or acetone maybe used. The drying may be performed by heat-drying, or may be performed by air-blow drying, vacuum drying or the like. When the drying is performed by heat-drying, the heating temperature is typically from 50 to 300° C., preferably about from 100 to 200° C. The washing and drying may be performed twice or more.

While the mixing method may be either of dry mixing and wet mixing, dry mixing is preferred in terms of convenience. Examples of the mixing device include a stirring type mixing device, a V-type mixer, a w-type mixer, a ribbon mixer, a drum mixer and a ball mill. While the temperature for calcining is depend on the kind of a used sodium compound, the calcining may be performed by keeping the mixture at a temperature of usually about from 400 to 1200° C., and the temperature is preferably from about 500 to 1000° C. The time for keeping the temperature is usually from 0.1 to 20 hours, and preferably from 0.5 to 10 hours. The heating rate to the temperature is usually from 50 to 400° C./hour, and the cooling rate from the temperature to room temperature is usually from 10 to 400° C./hour. The air, oxygen, nitrogen, argon or a mixture gas thereof may be used for an atmosphere of the calcining, and the air is preferred.

The crystallinity of the produced sodium-containing transition metal oxide to be produced and the average particle diameter of particles constituting the sodium-containing transition metal oxide can be controlled by using a adequate amount of a halide such as a fluoride or a chloride as the metal-containing compound. In this case, the halide may serve as a reaction accelerator (flux. Examples of the flux include NaF, MnF₃, FeF₂, NiF₂, CoF₂, NaCl, MnCl₂, FeCl₂, FeCl₃, NiCl₂, CoCl₂, NH₄Cl and NH₄T, and these can be used as raw materials (the metal-containing compounds) for the mixture, or added in a adequate amount to the mixture. The flux may be a hydrate.

Other examples of the metal-containing compound include Na₂CO₃, NaHCO₃, B₂O₃ and H₃BO₃.

When the sodium-containing transition metal oxide used for the present invention is used as a positive electrode active material for a sodium secondary battery, the sodium-containing transition metal oxide obtained as described above may be preferably subjected to pulverization with optionally using a conventional device used in industry such as a ball mill, a jet-mill or a vibration mill, and then subjected to washing, classification or the like to control the particle size of the oxide. The calcining maybe performed twice or more. A surface treatment such as coating the surface of the particle of the sodium-containing transition metal oxide with an inorganic substance containing Si, Al, Ti, Y, etc. may be performed.

In the case of performing a heat treatment after the surface treatment, depending on the temperature of the heat treatment, the BET specific surface area of the powder after the heat treatment may become smaller than the range of the BET specific surface area before the surface treatment.

### <Negative Electrode>

As a negative electrode usable for the sodium secondary battery of the present invention, an electrode in which a negative electrode mixture containing a negative electrode active material capable of being doped and dedoped with sodium ions is supported on a negative electrode current collector, a sodium metal electrode, or a sodium alloy electrode may be used. Besides the sodium metal and the sodium alloy described above, examples of the negative electrode active material include carbon materials capable of being doped and dedoped with sodium ions such as natural graphite, artificial graphite, coke, carbon black, pyrolytic carbon, carbon fiber and baked organic polymer compound, as well as metal. The shape of the carbon material is, for example, flaky like natural graphite, spherical like a rue so carbon microbead, fibrous like a graphitized carbon fiber, or an agglomerate of a fine powder. The carbon material may serve as a conductive material.

Examples of the carbon material include carbon black, pyrolytic carbon, carbon fiber and non-graphitized carbon materials such as baked organic polymer compound (hereinafter, maybe referred to as hard carbon). Examples of the hard carbon include carbon microbeads made of non-graphitized carbon materials and specifically include ICB (trade name: NICABEADS) manufactured by Nippon Carbon Co., Ltd.

Examples of the shape of particles constituting the carbon material include flaky like natural graphite, spherical like a mesocarbon microbead, fibrous like a graphitized carbon fiber, an agglomerate of a fine powder and so forth. When the shape of particles constituting the carbon material is spherical, the particles have an average particle diameter of preferably not smaller than 0.01 μm and not larger than 30 μm, and more preferably not smaller than 0.1 μm and not larger than 20 μm.

Examples of the metal used for the negative electrode active material specifically include tin, lead, silicon, germanium, phosphorus, bismuth, antimony, and so forth. Examples of the alloy include alloys containing two or more kinds of metals selected from the group consisting of the above-mentioned metals, alloys containing two or more kinds of metals selected from the group consisting of the above-mentioned metals and transition metals, as well as alloys such as Si—Zn, Cu₂Sb and La₃Ni₂Sn₇l. These metals and alloys in combination with a carbon material are supported on a current collector, and used as an electrode active material.

Examples of oxides used for the negative electrode active material Include Li₄Ti₅O₁₂ and so forth. Examples of sulfides include TiS₂, NiS₂, FeS₂, Fe₃S₄ and so forth. Examples of nitrides include Na₃₋ₓMₓN (herein, M represents a transition metal element; and 0≦x≦3) such as Na₃N and Na_{2.6}Co_{0.4}N, and so forth.

These carbon materials, metals, oxides, sulfides and nitrides may be used in combination with each other, and may be any of crystalline or amorphous. These carbon materials, metals, oxides, sulfides and nitrides are supported mainly on a current collector to be used as an electrode.

The negative electrode mixture may contain a binder and a conductive material according to the necessity. Examples of the binder and the conductive material include those which are the same as the binder used for the positive electrode.

Examples of the binder contained in the negative electrode mixture preferably include polyacrylic acid, sodium polyacrylate, lithium polyacrylate, potassium polyacrylate, carboxymethyl cellulose, hydroxymethyl cellulose, hydroxyethyl cellulose, hydroxypropyl cellulose, ethylene-vinyl acetate copolymer, styrene-butadiene copolymer, polyvinylidene fluoride, polytetrafluoroethylene, vinylidene fluoride-tetrafluoroethylene copolymer, vinylidene fluoride-hexafluoropropylene-tetrafluoroethylene copolymer, and so forth. One or more kinds of these binders may be used.

The ratio of the binder in the negative electrode mixture is usually about 0. 5 to 30 parts by -weight, and preferably about 2 to 20 parts by weight based on 100 parts by weight of the negative electrode active material such as a carbon material.

Examples of the negative electrode current collector include Al, Cu, Ni and stainless steel, and Al is preferred in terms of being easy to shape into a thin film and inexpensive. Examples of the shape of the current collector include a shape of foil, flat plate, mesh, net, lath, punching metal and embossed one, and combinations thereof (e.g., meshed flat plate). Irregularities may be formed on the surface of the current collector by etching.

### <Separator>

A separator usable for the sodium secondary battery of the present invention may be, for example, materials in the form of a porous film, a non-woven fabric, a fabric, etc., made of a polyolefin resin such as polyethylene or polypropylene, a fluororesin, a nitrogen-containing aromatic polymer, etc. The separator may be a single-layer or multilayer separator with two or more kinds of these materials. Examples of the separator include the separators described in, for example, JP-A-2900-30636 and JP-A-10-324758. As long as the mechanical strength is maintained, the thickness of the separator is preferably as small as possible from the viewpoint that the volume energy density of the battery will increase and the internal resistance will decrease. Generally, the thickness of the separator is preferably about 5 to 200 μm, and more preferably about 5 to 40 μm.

Preferably, the separator has a porous film containing a thermoplastic resin. In a secondary battery, it is usually important to prevent flow of electric current in excess by blocking the current (to shutdown) when an abnormal electrical current flows in the battery due to a short circuit or the like between the positive electrode and the negative electrode. Therefore, it is required that the sepertator cause shutdown at a temperature as low as possible when it exceeds a normal operating temperature (if the separator has a porous film containing a thermoplastic resin, micropores of the porous film are closed), and that, even if the temperature inside the battery rises to a certain level of higher temperature after the shutdown, the separator film is not broken at the higher temperature to keep the shutdown. In other words, the separator is required to have high heat resistance. By using, as the separator, a separator composed of a laminated porous film in which a heat-resistant porous layer containing a heat-resistant-resin and a thermoplastic resin-containing porous film are laminated with each other, it becomes possible to further prevent the film from being broken by heat in the secondary battery of the present invention. The heat-resistant porous layer may be laminated on both sides of the porous film.

The heat-resistant porous layer is a layer with higher heat resistance than the porous filmy and the heat-resistant porous layer may be made of an inorganic powder or may contain a heat-resistant resin.

Examples of the heat-resistant resin include polyamide, polyimide, polyamide-imide, polycarbonate, polyacetal, polysulfone, polyphenylene sulfide, polyether ketone, aromatic polyester, polyether sulfone and polyetherimide. In terms of further enhancing the neat resistance, polyamide, polyimide, polyamide-imide, polyether sulfone and polyetherimide are preferable, and polyamide, polyimide and polyamide-imide are more preferable, and nitrogen-containing aromatic polymers such as aromatic polyamides (para-oriented aromatic polyamides and meta-oriented aromatic polyamides), aromatic polyimides and aromatic polyamide-imides are further more preferable, and aromatic polyamides are especially preferable, and para-oriented aromatic polyamides (hereinafter may be referred to as “para-aramids”) are particularly preferable in terms of production.

Examples of the inorganic powder include powders of inorganic materials such as metal oxides, metal nitrides, metal carbides, metal hydroxides, carbonates and sulfates, and among these, a powder of an inorganic material with low conductivity is used preferably. Specific examples thereof include powders of alumina, silica, titanium dioxide, calcium and so forth. These inorganic powders may be used alone or two or more of inorganic powders may be used in the form of a mixture. An alumina powder is preferable among these inorganic powders in terms of chemical stability. Herein, it is more preferable that all the particles constituting filler are alumina particles. and it is furthermore preferable that all the particles constituting filler are alumina particles and part or all of them are substantially spherical alumina particles. Incidentally, when the heat-resistant porous layer is made of an inorganic powder, the above-mentioned inorganic powders may be used, and may be mixed with the binder if necessary.

### EXAMPLES

Hereinafter, the present invention will be described more in detail with reference to Examples. Various evaluations on the sodium-containing transition metal compound were performed by the measurements below.

### 1. Powder X-ray Diffraction Measurement of Sodium-Containing Transition Metal Compound

The powder X-ray diffraction measurement of the sodium-containing transition metal compound was performed by RINT2500TTR type manufactured by Rigaku Corporation. In the measurement, the sodium-containing transition metal compound was charged into an exclusive holder, and then measured in a range or the diffraction angle 2θ of 10 to 90° C. with a Cu Kα ray source, whereby a powder X-ray diffraction pattern was obtained.

### 2. Composition Analysis of Sodium-Containing Transition Metal Compound

After the powder was dissolved in hydrochloric acid, the measurement was performed by inductively coupling plasma emission spectrometry (SPS 3000, manufactured by SII; hereinafter, may be referred to as ICP-AES).

### <Production Example 1> (Production of Composite Metal Oxide A1 and Positive Electrode AE¹)

In a beaker made of polypropylene, 44.88 g of potassium hydroxide was added to 300 ml of distilled water, and dissolved by stirring until it was completely dissolved to prepare an aqueous potassium hydroxide solution (precipitant). In another beaker made of polypropylene, 21.21 g of iron(II) chloride tetrahydrate, 19.02 g of nickel(II) chloride hexahydrate, and 15.83 g of manganese(II) chloride tetrahydrate were added to 300 ml of distilled water and dissolved by stirring to give an aqueous iron-nickel-manganese-containing solution. The aqueous iron-nickel-manganese-containing solution was added dropwise to the precipitant while stirring the precipitant, and thus a slurry with a precipitate produced was obtained. Subsequently, the slurry was filtered, washed with distilled water, and dried at 100° C. to obtain the precipitate. The precipitate, sodium carbonate and calcium hydroxide were weighed in such a way that the molar ratio of Fe:Na:Ga became 0.4:0.99:0.01, and then dry mixing was performed in an agate mortar to obtain a mixture. Subsequently, the mixture was put in a calcining container made of alumina, calcined by an electric furnace in the air atmosphere at 850° C. for 6 hours, and then cooled to room temperature, whereby the composite metal oxide A¹ was obtained. The powder X-ray diffraction analysis was performed on the composite metal oxide A¹, and consequently it was found that the composite metal oxide is attributed to α-NaFeO₂ type of crystal structure. Further, the composite metal oxide A¹ was analyzed in composition by ICP-AES and thus, the molar ratio of Na:Ca:Fe:Ni:Mn was found to be 0.99: 0.01:0.4:0.3:0.3. Thereafter, a positive electrode mixture paste was prepared by using the composite metal oxide A¹ obtained as described above, acetylene black (HS100, manufactured by Denki Kagaku Kogyo Kabushiki Kaisha) as a conductive material, VT 471 (manufactured by Dalkin Industries, Ltd.) as a binder solution and NMP (manufactured by Kishida Chemical Co., Ltd.) as a solvent. The positive electrode mixture paste was obtained by weighing the composite metal oxide A¹, the conductive material, the binder and NMP so as to be a composition having a weight ratio of 90:5:5:100 for composite metal oxide A¹:conductive material:binder:NMP, and stirring and mixing these components at 2000 rpm for 5 minutes by DISPERMAT (manufactured by VMA-GETZMANN). The resulting positive electrode mixture paste was applied to an aluminum foil with a thickness of 20 μm by using a doctor blade, dried at 60° C. for 2 hours, and then rolled at a pressure of 200 kN/m by using a roll press (SA-602, manufactured by Tester Sangyo Co., Ltd.) to obtain a positive electrode AE¹.

### <Production Example 2> (Production of Carbon Material C¹ and Carbon Electrode CE¹)

After ICB (tradename: NICABEADS) manufactured by Nippon Carbon Co., Ltd. was introduced into a calcining furnace and the inside of the furnace was in an argon gas atmosphere, the temperature was increased from room: temperature to 1600° C. at a heating rate of 5° C./minute, kept at 1600° C. for 1 hour, and then cooled while argon gas is circulated at 0.1 L/g (weight of carbon material; per minute to obtain a carbon material C¹. An electrode mixture paste was made by using the carbon material C¹ carboxymethyl cellulose (CMC)(Cellogen 4H, manufactured by Dai-Ichi Kogyo Seiyaku Co., Ltd.) and styrene-butadiene rubber (SBR) (AL 3001, manufactured by Nippon A&L Inc.) as binders, and water as a solvent. The electrode mixture paste was obtained by making a binder solution having the binders dissolved in water, weighing the carbon material C¹, CMC, SBR and water so as to be a composition having a weight ratio of 97:2:1:150 for C¹:CMC:SBR:water, and stirring and mixing these components by DISPERMAT (manufactured by VMA-GETZMANN). The rotating condition of rotary blades was 2,000 rpm for 5 minutes. The resulting electrode mixture paste was applied to a copper foil by using a doctor blade, dried at 60° C. for 2 hours, and then rolled at 125 kN/m by using a roll press to obtain a carbon electrode CE¹.

### Example 1 (Production of Sodium Secondary Battery B¹)

The positive electrode AE¹ punched into 14.5 mm diameter was put in a dimple at a lower part of a coin cell (manufactured by Hohsen Corp.). A mixed solution obtained by mixing a solution of 1.0 mol/L NaPF₆/propylene carbonate (1.0 M NaPF6/PC) (manufactured by bishida Chemical Co., Ltd.) and (trifluoromethyl)trimethylsilane (hereinafter, referred to as TFMTMS) (manufactured by Wako Pure Chemical Industries, Ltd.) at a volume ratio of 99.9:0.1 was used as a non-aqueous electrolyte (NaPF₆ concentration in the non-aqueous electrolyte; 1.0 mol/L). A porous polyethylene film (thickness: 20 μm) as a separator and metal sodium (manufactured by Aldrich) as a negative electrode were combined to make a sodium secondary battery B¹. The assembly of the battery was performed in a glove box in an argon atmosphere, and TFMTMS was subjected to dehydration treatment with molecular sieve 3A before use, and thereafter used.

### Example 2 (Production of Sodium Secondary Battery B²)

A sodium secondary battery B² was made in the same manner as in Example 1, except that a mixed solution obtained by mixing 1.0 M NaPF₆/PC and TFMTMS at a volume ratio of 99.5:0.5 was used as a non-aqueous electrolyte (NaPF₆ concentration in the non-aqueous electrolyte: 1.0 mol/L).

### Example 3 (Production of Sodium Secondary Battery B³)

A sodium secondary battery B³ was made in the same manner as in Example 1, except that a mixed solution obtained by mixing 1.0 M NaPF₆/PC and TFMTMS at a volume ratio of 99.0:1.0 was used as a non-aqueous electrolyte (NaPF₆ concentration in the non-aqueous electrolyte: 0.99 mol/L).

### Example 4 (Production of Sodium Secondary Battery B⁴)

A sodium secondary battery B⁴ was made in the same manner as in Example 1, except that a mixed solution obtained by mixing 1.0 H NaPF₆/PC and TFMTMS at a volume ratio of 95.2:4.8 was used as a non-aqueous electrolyte (NaPF₆ concentration in the non-aqueous electrolyte: 0.95 mol/L).

### Example 5 (Production of sodium secondary battery B⁵)

A sodium secondary battery B⁶ was made in the same manner as in Example 1, except that a mixed solution obtained by mixing 1.0 M NaPF₆/PC, fluoroethylene carbonate (hereinafter, referred to as FEC) (manufactured by Kishida Chemical Co., Ltd.) serving as a cyclic carbonic acid ester containing a fluorine atom, and TFMTMS at a volume ratio of 97.5:2.0:0.5 was used as a non-aqueous electrolyte (NaPF₆ concentration in the non-aqueous electrolyte: 0.98 mol/L).

### Example 6 (Production of Sodium Secondary Battery B⁶)

A sodium secondary battery B⁶ was made in the same manner as in Example 1, except that a mixed solution obtained by mixing 1.0 M NaPF₆/PC and triethoxyfluorosilane (hereinafter, referred to as TEES) (manufactured by Wako Pure Chemical Industries, Ltd.) at a volume ratio of 99.5:0.5 was used as a non-aqueous electrolyte (NaPF₆ concentration in the non-aqueous electrolyte: 1.0 mol/L). TEFS was subjected to dehydration treatment with molecular sieve 3A before use, and thereafter used.

### Comparative Example 1 (Production of Sodium Secondary Battery E¹)

A sodium secondary battery B⁶ was made in the same manner as in Example 1, except that 1.0 M NaPF₆/PC (manufactured by Kishida Chemical Co., Ltd.) was used as a non-aqueous electrolyte (NaPF₆ concentration in the non-aqueous electrolyte: 1.0 mol/L).

### Example 7 (Production of Sodium Secondary Battery B⁷)

A sodium secondary battery B⁷ was made in the same manner as in Example 1, except that a mixed solution obtained by mixing 1.3 M NaPF₆/PC (manufactured by Kishida Chemical Co., Ltd.), sulfolane (hereinafter, referred to as SL) (manufactured by Kishida Chemical Co. , Ltd.) and TFMTMS at a volume ratio of 76.5:22.5:1.0 was used as a non-aqueous electrolyte (NaPF₆ concentration in the non-aqueous electrolyte: 0.99 mol/L).

### Comparative Example 2 (Production of Sodium Secondary Battery (E²)

A sodium secondary battery E² was made in the same manner as in Example 1, except that a mixed solution obtained by mixing 1.3 M NaPF₆/PC and SL at a volume ratio of 77:23 was used as a non-aqueous electrolyte (NaPF₆ concentration in the non-aqueous electrolyte: 1.0 mol/L).

### Example 8 (Production of Sodium Secondary Battery B⁸)

A sodium secondary battery B⁸ was made in the same manner as in Example 1, except that a mixed solution obtained by mixing a solution of 1.0 M/L NaPF₆/ethylene carbonate:dimethyl carbonate=50:50 (1.0 M NaPF₆/EC:DMC=50:50) and TFMTMS at a volume ratio of 93.5:0.5 was used as a non-aqueous electrolyte (NaPF₆ concentration in the non-aqueous electrolyte: 1.0 mol/L).

### Comparative Example 3 (Production of Sodium Secondary Battery E³)

A sodium secondary battery E³ was made in the same manner as in Example 1, except that 1.0 M NaPF₆/EC:DMC=50:50 was used as a non-aqueous electrolyte (NaPF₆ concentration in the non-aqueous electrolyte: 1.0 mol/L).

### <Charge-Discharge Test>

CC-CV (constant current-constant voltage, charge was completed after 30 hours in total had passed) charge was performed from a rest potential to 4.1 V at a 0.1 C rate (a rate that requires 10 hours for full charge), the battery was then left in a resting state for 120 hours, and thereafter CC (constant current) discharge to 2.0V was performed at a 0.1 C rate (a rate that requires 10 hours for full charge). Table 1 shows charge-discharge test results of the sodium secondary batteries B¹ to B⁶ and E¹; Table 2 shows charge-discharge test results of the sodium secondary batteries B⁷ and E²; and Table 3 shows charge-discharge test results of the sodium secondary batteries B⁸ and E³. The charge-discharge efficiency was calculated according to the following equation.

Charge-discharge efficiency (%)=[(discharge capacity of each sodium secondary battery)/(charge capacity of each sodium secondary battery)]×100

The discharge capacity ratio in the tables was calculated according to the following equation.

Discharge capacity ratio (%)=[(discharge capacity of each example)/(discharge capacity of each comparative example)]×100

TABLE 1

| | | Non-aqueous electrolyte | | | | | |
|---|---|---|---|---|---|---|---|
| | | | | Silane | Cyclic carbonic acid | Charge- | Discharge |
| | Sodium | | Non-aqueous | compound | ester containing | discharge | capacity |
| | secondary | Sodium salt | solvent (% | (% by | fluorine atom (% by | efficiency | ratio |
| | battery | (electrolyte) | by volume) | volume) | volume) | (%) | (%) |
| Example 1 | B¹ | 1.0M | PC | TFMTMS | — | 78.2 | 100 |
| | | NaPF₆ | 99.9 | 0.1 | | | |
| Example 2 | B² | 1.0M | PC | TFMTMS | — | 79.4 | 101 |
| | | NaPF₆ | 99.5 | 0.5 | | | |
| Example 3 | B³ | 0.99M | PC | TFMTMS | — | 82.9 | 111 |
| | | NaPF₆ | 99.0 | 1 | | | |
| Example 4 | B⁴ | 0.95M | PC | TFMTMS | — | 78.8 | 100 |
| | | NaPF₆ | 95.2 | 4.8 | | | |
| Example 5 | B⁵ | 0.98M | PC | TFMTMS | FEC | 80.4 | 103 |
| | | NaPF₆ | 97.5 | 0.5 | 2 | | |
| Example 6 | B⁶ | 1.0M | PC | TEFS | — | 79.9 | 101 |
| | | NaPF₆ | 99.5 | 0.5 | | | |
| Comparative | E¹ | 1.0M | PC | — | — | 75.2 | 100 |
| Example 1 | | NaPF₆ | 100 | | | | |

TABLE 2

| | | Non-aqueous electrolyte | | | | | | |
|---|---|---|---|---|---|---|---|---|
| | | | Non-aqueous | | Silane | Cyclic carbonic acid | Charge- | Discharge |
| | Sodium | | solvent | | compound | ester containing | discharge | capacity |
| | secondary | sodium salt | (% by | | (% by | fluorine atom | efficiency | ratio |
| | battery | (electrolyte) | volume) | | volume) | (% by volume) | (%) | (%) |
| Example 7 | B⁷ | 0.99M | PC | SL | TFMTMS | — | 83.2 | 100 |
| | | NaPF₆ | 76.5 | 22.5 | 1 | | | |
| Comparative | E² | 1.0M | PC | SL | — | — | 81.5 | 100 |
| Example 2 | | NaPF₆ | 77.0 | 23.0 | | | | |

TABLE 3

| | | Non-aqueous electrolyte | | | | | |
|---|---|---|---|---|---|---|---|
| | | | Non-aqueous | Silane | Cyclic carbonic acid | Charge- | Discharge |
| | Sodium | | solvent | compound | ester containing | discharge | capacity |
| | secondary | sodium salt | (% by | (% by | fluorine atom | efficiency | ratio |
| | battery | (electrolyte) | volume) | volume) | (% by volume) | (%) | (%) |
| Example 8 | B⁸ | 1.0M | EC/DMC | TFMTMS | — | 72.3 | 124 |
| | | NaPF₆ | 99.5 | 0.5 | | | |
| Comparative | E³ | 1.0M | EC/DMC | — | — | 48.8 | 100 |
| Example 3 | | NaPF₆ | 100 | | | | |

### Example 9 (Production of sodium secondary battery IB¹)

The positive electrode AE¹ punched into 14.5 mm diameter was put in a dimple at a lower part of a coin cell (manufactured by Hohsen Corp.). A mixed solution obtained by mixing 1.0 M NaPF₆/PC, FEC and TFMTMS at a volume ratio of 97.5:2.0:0.5 was used as a non-aqueous electrolyte (NaPF₆ concentration in the non-aqueous electrolyte: 0.90 mol/L). A porous

polyethylene film (thickness: 20 Jim) as a separator and the carbon electrode CE¹ punched into 15.0 mm diameter as a negative electrode were combined to make a sodium secondary battery IB¹. The assembly of the battery was performed in a glove box in an argon atmosphere, and TFMTMS was subjected to dehydration treatment with molecular sieve 3A before use, and thereafter used.

### Example 10 (Production of Sodium Secondary Battery IB²)

A sodium secondary battery IB² was made in the same manner as in Example 9, except that a mixed solution obtained by mixing 1.0 M NaPF₆/PC, FEC and TFMTMS at a volume ratio of 97.0:2.0: 1.0 was used as a non-aqueous electrolyte (NaPF₆ concentration in the non-aqueous electrolyte: 0.97 mol/L).

### Example 11 (Production of Sodium Secondary Battery IB³)

A sodium secondary battery IB³ was made in the same manner as in Example 9, except that a mixed solution obtained by mixing 1.0 M NaPFe/PC, FEC and TEES at a volume ratio of 97.5:2.0: 0.5 was used as a non-aqueous electrolyte (NaPF₆ concentration in the non-aqueous electrolyte: 0.98 mol/L). TEFS was subjected to dehydration treatment by molecular sieve 3A before use, and thereafter used.

### Example 12 (Production of Sodium Secondary Battery IB⁴)

A sodium secondary battery IB⁴ was made in the same manner as in Example 9, except that a mixed solution obtained by mixing 1.0 M NaPF₆/PC, FEC and trimethoxy(3,3,3-trifluoropropyl)silane (hereinafter, referred to as TMTFPS) (manufactured by Aldrich) at a volume ratio of 97.0:2.0:1.0 was used as a non-aqueous electrolyte (NaPF₆ concentration in the non-aqueous electrolyte: 0.97 mol/L).

### Comparative Example 4 (Production of Sodium Secondary Battery IE¹)

A sodium secondary battery IE¹ was made in the same manner as in Example 9, except that a mixed solution obtained by mixing 1.0 M NaPF₆/PC and FEC at a volume ratio of 98:2 was used as a non-aqueous electrolyte (NaPF₆ concentration in the non-aqueous electrolyte: 0.98 mol/L).

### <Charge-Discharge Test>

CC-CV (constant current-constant voltage, charge was completed when electric current reached 0.02 C) charge was performed from a rest potential to 4 .1 V at a 0.1 C rate (a rate that requires 10 hours for full charge), and thereafter CC (constant current) discharge to 2.0 V was performed at a 0.1 C rate (a rate that requires 10 hours for full charge). Table 4 shows charge-discharge test results of the sodium secondary batteries IB¹ to IB⁴ and IE¹. The charge-discharge efficiency was calculated according to the following equation.

Charge-discharge efficiency (%)=[(discharge capacity of each sodium secondary battery)/(charge capacity of each sodium secondary battery)]×100

The discharge capacity ratio in the tables was calculated according to the following equation.

Discharge capacity ratio (%)=[(discharge capacity of each example)/(discharge capacity of each comparative example)]×100

TABLE 4

| | | Non-aqueous electrolyte | | | | | |
|---|---|---|---|---|---|---|---|
| | | | Non-aqueous | Silane | Cyclic carbonic acid | Charge- | Discharge |
| | Sodium | | solvent | compound | ester containing | discharge | capacity |
| | secondary | sodium salt | (% by | (% by | fluorine atom | efficiency | ratio |
| | battery | (electrolyte) | volume) | volume) | (% by volume) | (%) | (%) |
| Example | IB¹ | 0.98M | PC | TFMTMS | FEC | 77.4 | 106 |
| 9 | | NaPF₆ | 97.5 | 0.5 | 2 | | |
| Example | IB² | 0.97M | PC | TFMTMS | FEC | 79.8 | 112 |
| 10 | | NaPF₆ | 97.0 | 1 | 2 | | |
| Example | IB³ | 0.98M | PC | TEFS | FEC | 77.1 | 105 |
| 11 | | NaPF₆ | 97.5 | 0.5 | 2 | | |
| Example | IB⁴ | 0.97M | PC | TMTFPS | FEC | 77.8 | 109 |
| 12 | | NaPF₆ | 97.0 | 1 | 2 | | |
| Comparative | IE¹ | 0.98M | PC | — | FEC | 75.3 | 100 |
| Example 4 | | NaPF₆ | 98.0 | | 2 | | |

Usefulness or the present invention was proved from the results in Tables 1 to 4.

### INDUSTRIAL APPLICABILITY

The present invention can provide a sodium secondary battery with high charge-discharge efficiency.

1. A sodium secondary battery comprising a positive electrode containing a positive electrode active material capable of being doped and dedoped with sodium ions, a negative electrode containing a negative electrode active material capable of being doped and dedoped with sodium ions, and a non-aqueous electrolyte in which a sodium salt is dissolved in a non-aqueous solvent, wherein the non-aqueous electrolyte contains a silane compound represented by the following formula (1): 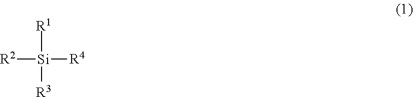
(wherein, R¹ to R⁴ each independently represent a fluorine atom, an alkyl group having 1 to 8 carbon atoms, a fluoroalkyl group having 1 to 8 carbon atoms, an alkoxy group having 1 to 8 carbon atoms, or a fluoroalkoxy group having 1 to 8 carbon atoms; and at least one of R¹ to R⁴ is a fluorine atom, a fluoroalkyl group having 1 to 8 carbon atoms, or a fluoroalkoxy group having 1 to 8 carbon atoms).

2. The sodium secondary battery according to claim 1, wherein the non-aqueous electrolyte contains the silane compound in a range of not less than 0.01% by volume and not more than 10% by volume in the non-aqueous electrolyte.

3. The sodium secondary battery according to claim 1, wherein the non-aqueous electrolyte further contains one or more compound selected from the group consisting of a cyclic carbonic acid ester, a cyclic sulfone, a lactone and a cyclic sulfonic acid ester.

4. The sodium secondary battery according to claim 1, wherein the non-aqueous electrolyte contains a cyclic carbonic acid ester containing a fluorine atom, and the non-aqueous electrolyte contains the cyclic carbonic acid ester containing a fluorine atom in a range of not less than 0.01% by volume and not more than 10% by volume in the non-aqueous electrolyte.

5. The sodium secondary battery according to claim 1, wherein the non-aqueous electrolyte contains NaPF₆ as a sodium salt.

6. The sodium secondary battery according to claim 1, wherein the silane compound is represented by the following formula (1-1) or (1-4): 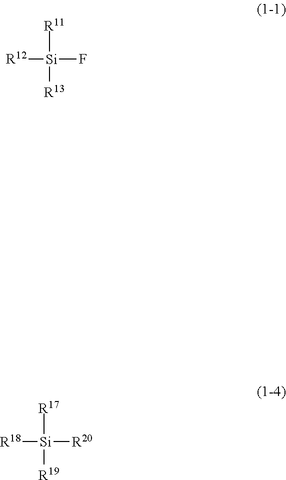
(wherein, R¹¹, R^{12, R}^{13, R}^{17, R}¹⁸ and R¹⁹ each independently represent an alkyl group having 1 to 8 carbon atoms, a fluoroalkyl group having 1 to 8 carbon atoms, an alkoxy group having 1 to 8 carbon atoms, or a fluoroalkoxy group having 1 to 8 carbon atoms; and R²⁰ is a fluoroalkyl group having 1 to 8 carbon atoms or a fluoroalkoxy group having 1 to 8 carbon atoms).

7. The sodium secondary battery according to claim 1, wherein the positive electrode active material is a composite metal oxide represented by the following formula (A):
NaₐM¹_{b}M²O₂ (A)
(wherein, M¹ represents one or more elements selected from the group consisting of Mg, Ca, Sr and Ba; M² represents one or more elements selected from the group consisting of Mn, Fe, Co, Cr, V, Ti and Ni; a is a value in a range of not less than 0.5 and not more than 1; b is a value in a range of not less than 0 and not more than 0.5; and a+b is a value in a range of not less than 0.5 and not more than 1).
